(19) United States
(12) Patent Application Publication
(10) Pub. No.: US 2025/0390911 A1
(43) Pub. Date: Dec. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Toshinori MIYOSHI, Tokyo (JP); Koji TSUKAMOTO, Tokyo (JP); Hiromu YAMAWAKI, Tokyo (JP); Takahiro ISHIKAWA, Tokyo (JP)

(21) Appl. No.: 19/072,794

(22) Filed: Mar. 6, 2025

(30) Foreign Application Priority Data
Jun. 20, 2024 (JP) 2024-099958

(51) Int. Cl. G06Q 30/0251

(52) U.S. Cl. CPC G06Q 30/0255

(57) ABSTRACT

An information processing apparatus according to the present application includes an identification unit, an inquiry unit, a generation unit, and a providing unit. The identification unit identifies a plurality of personal agents each being associated with a corresponding user among a plurality of users who are grouped. The inquiry unit makes an inquiry to the plurality of personal agents that are identified by the identification unit about information that is used to provide an advertisement to a group corresponding to the plurality of users. The generation unit generates advertisement selection information that is information that is used to select the advertisement by using pieces of information that are provided by the plurality of personal agents in response to the inquiry that is made by the inquiry unit. The providing unit provides the advertisement selection information that is generated by the generation unit to an advertisement provider.

### CROSS-REFERENCE TO RELATED APPLICATIONS

The present application claims priority to and incorporates by reference the entire contents of Japanese Patent Application No. 2024-099958 filed in Japan on Jun. 20, 2024.

### BACKGROUND OF THE INVENTION

### 1. Field of the Invention

The present invention relates to an information processing apparatus, an information processing method, and an information processing program.

### 2. Description of the Related Art

Conventionally, a technology for providing an advertisement via a network is known. For example, Japanese Laid-open Patent Publication No. 2022-180282 proposes a technology for forming a chat group that includes a user and at least one of a staff member in a customer service store and a cast who belongs to the customer service store, and providing a reservation guidance advertisement in a chat room.

However, in the conventional technology as described above, a technology for enabling provision of a more appropriate advertisement to a user in the chat group, and there is room for improvement in enabling provision of a more appropriate advertisement to the user in the chat group.

### SUMMARY OF THE INVENTION

An information processing apparatus according to the present application includes an identification unit, an inquiry unit, a generation unit, and a providing unit. The identification unit identifies a plurality of personal agents each being associated with a corresponding user among a plurality of users who are grouped. The inquiry unit makes an inquiry to the plurality of personal agents that are identified by the identification unit about information that is used to provide an advertisement to a group corresponding to the plurality of users. The generation unit generates advertisement selection information that is information that is used to select the advertisement by using pieces of information that are provided by the plurality of personal agents in response to the inquiry that is made by the inquiry unit. The providing unit provides the advertisement selection information that is generated by the generation unit to an advertisement provider.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to one embodiment;

FIG. 2 is a diagram illustrating an example of a configuration of an information processing system according to one embodiment;

FIG. 3 is a diagram illustrating an example of a configuration of an information processing apparatus according to one embodiment;

FIG. 4 is a diagram illustrating an example of a user information table that is stored in a user information storage unit of the information processing apparatus according to one embodiment;

FIG. 5 is a diagram illustrating an example of a chat setting information table that is stored in a chat setting information storage unit of the information processing apparatus according to one embodiment;

FIG. 6 is a diagram illustrating an example of a conversation history table that is stored in a conversation history storage unit of the information processing apparatus according to one embodiment;

FIG. 7 is a diagram illustrating an example of a configuration of a group agent processing unit in a processing unit of the information processing apparatus according to one embodiment;

FIG. 8 is a diagram illustrating an example of a configuration of a generation unit in the processing unit of the information processing apparatus according to one embodiment;

FIG. 9 is a diagram illustrating an example of an advertisement that is provided to a terminal apparatus by a providing unit in the processing unit of the information processing apparatus according to one embodiment and that is displayed on the terminal apparatus;

FIG. 10 is a flowchart illustrating an example of information processing that is performed by the processing unit of the information processing apparatus according to one embodiment; and

FIG. 11 is a diagram illustrating an example of a hardware configuration of a computer that implements functions of the information processing apparatus according to one embodiment.

### DETAILED DESCRIPTION OF THE PREFERRED EMBODIMENTS

Modes (hereinafter, described as “embodiments”) for carrying out an information processing apparatus, an information processing method, and an information processing program according to the present application will be described in detail below with reference to the drawings. Meanwhile, the information processing apparatus, the information processing method, and the information processing program according to the present application are not limited by the embodiments below. Further, the embodiments may be combined appropriately as long as processing contents do not conflict with each other. Furthermore, in each of the embodiments described below, the same components are denoted by the same reference symbols, and repeated explanation will be omitted.

### 1. One Example of Information Processing

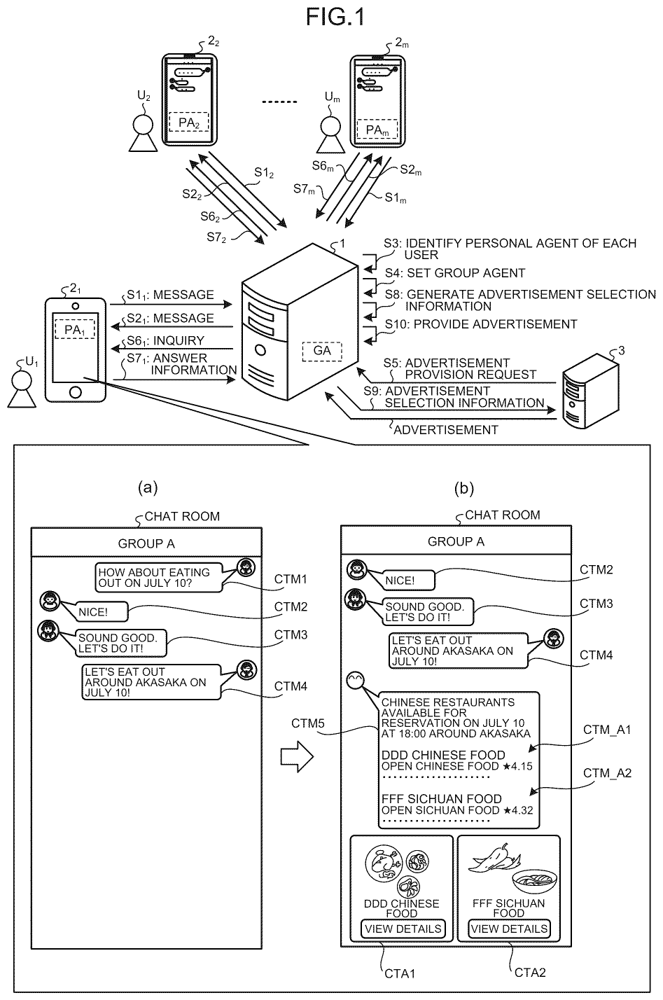

FIG. 1 is a diagram illustrating an example of information processing according to one embodiment, and, in the present embodiment, an information processing apparatus implements an information processing method.

As illustrated in FIG. 1, an information processing apparatus 1 is communicably connected to terminal apparatuses 2₁, 2₂, . . . , 2ₘ and an advertisement distribution apparatus 3, and transmits and receives information to and from the terminal apparatuses 2₁, 2₂, . . . , 2ₘ and the advertisement distribution apparatus 3. m is, for example, an integer equal to or larger than three.

The information processing apparatus 1 provides a chat service for transmitting and receiving a chat message among the terminal apparatuses 2₁, 2₂, . . . , 2ₘ to users U₁, U₂, . . . , Uₘ of the terminal apparatuses 2₁, 2₂, . . . , 2ₘ.

The advertisement distribution apparatus 3 provides an advertisement distribution service. In the advertisement distribution service, the advertisement distribution apparatus provides advertisements to the terminal apparatuses 2₁, 2₂, . . . , 2ₘ and displays the advertisements on the terminal apparatuses 2₁, 2₂, . . . , 2ₘ.

The terminal apparatus 2₁ is used by the user U₁, the terminal apparatus 2₂ is used by the user U₂, and the terminal apparatus 2ₘ is used by the user Uₘ. The users U₁, U₂, . . . , Uₘ are participants to the same chat group, and an application of an instant messenger for performing a group chat that is a chat performed by a chat group is installed in each of the terminal apparatuses 2₁, 2₂, . . . , 2ₘ. In the following, the application of the instant messenger may be described as a chat application.

The instant messenger is able to transmit and receive a message in the group chat, transmit and receive a message in a one-to-one chat, transmit and receive a message in a one-to-many chat, or the like. Examples of the message that is transmitted and received by the chat application includes a character, a stamp, and a captured image.

In the following, when each of the terminal apparatuses 2₁, 2₂, . . . , 2ₘ is described without being individually distinguished, each of the terminal apparatuses 2₁, 2₂, . . . , 2ₘ may be described as a terminal apparatus 2, and, when each of the users U₁, U₂, . . . , Uₘ is described without being individually distinguished, each of the users U₁, U₂, . . . , Uₘ may be described as a user U. The terminal apparatus 2 may be, for example, a smartphone, a tablet Personal Computer (PC), a notebook PC, or the like.

Each of the users U₁, U₂, . . . , Uₘ operates a corresponding terminal apparatus among the terminal apparatuses 2₁, 2₂, . . . , 2ₘ, and exchanges a message in the chat group. Specifically, each of the users U₁, U₂, . . . , Uₘ operates a corresponding terminal apparatus among the terminal apparatuses 2₁, 2₂, . . . , 2ₘ, and transmits a message of the group chat to the information processing apparatus 1 via a network (not illustrated) (Steps S1₁, S1₂, . . . S1ₘ).

The information processing apparatus 1 receives a message of the group chat, which is transmitted from the terminal apparatuses 2₁, 2₂, . . . , 2ₘ, and transmits the received message of the group chat to the terminal apparatuses 2 of the users U other than the user U who has transmitted the message via the network (not illustrated) (Step S2₁, S2₂, . . . S2ₘ). The terminal apparatuses 2₁, 2₂, . . . , 2ₘ receive a chat message that is a message of the group chat and that is transmitted from the information processing apparatus 1, and displays the received chat message in a chat room of the group chat.

In an example illustrated in (a) in FIG. 1, the terminal apparatus 2₁ displays chat messages CTM1 and CTM4 of the user U₁, a chat message CTM2 of the user U₂, and a chat message CTM3 of the user Uₘ. Further, a name of the chat group is a group A.

Furthermore, the information processing apparatus 1 identifies a plurality of personal agents PA₁, PA₂, . . . , PAₘ each of which is associated with a corresponding user among the plurality of users U₁, U₂, . . . , Uₘ who are grouped as the group A that is a chat group (Step S3).

The information processing apparatus 1 identifies a personal agent of a chat application in which a user IDentifier (ID) of the user U is set, as a personal agent of the user U. The user ID is an account of the user U that is set in the chat application.

For example, the information processing apparatus 1 identifies, as the personal agent PA₁, a personal agent of the chat application in which the user ID of the user U₁ is set and which operates on the terminal apparatus 2₁. Further, the information processing apparatus 1 identifies, as the personal agent PA₂, a personal agent of the chat application in which the user ID of the user U₂ is set and which operates on the terminal apparatus 2₂.

Furthermore, the information processing apparatus 1 identifies, as the personal agent PAₘ, a personal agent of the chat application in which the user ID of the user Uₘ is set and which operates on the terminal apparatus 2ₘ. In the following, when each of the personal agents PA₁, PA₂, . . . , PAₘ is described without being individually distinguished, each of the personal agents PA₁, PA₂, . . . , PAₘ may be described as a personal agent PA. The personal agent PA is a service agent for each of the users U, and may be, for example, Auto-GPT or the like.

The personal agent PA is one of functions that are included in the chat application, and functions as an agent for the user U. For example, the personal agent PA₁ functions as an agent for the user U₁, the personal agent PA₂ functions as an agent for the user U₂, and the personal agent PAₘ functions as an agent for the user Uₘ.

The information processing apparatus 1 performs the process at Step S3 before the processes at Step S1₁, S1₂, . . . S1ₘ, but embodiments are not limited to this example, and may perform the process at Step S3 before a process at Step S4. For example, the information processing apparatus 1 performs the process at Step S3 when the users U₁, U₂, . . . , Uₘ are grouped.

A timing at which the users U₁, U₂, . . . , Uₘ are grouped may be a timing at which the group A is set, a timing at which a chat room of the group A is created, or the like, but embodiments are not limited to this example. For example, the timing at which the users U₁, U₂, . . . , Uₘ are grouped may be a timing at which a chat message is posted in the chat room of the group A, or the like.

Furthermore, when the users U₁, U₂, . . . , Uₘ are grouped, the information processing apparatus 1 sets a group agent GA of the group A of the user U₁, U₂, . . . , Uₘ who are grouped (Step S4). The group agent GA is, for example, a service agent for each of groups, and may be, for example, Auto-GPT or the like. The group agent GA is set in units of groups; however, it may be possible to set a group agent across a plurality of groups or set a single group agent for all of groups.

The group agent GA transmits and receive information between the plurality of personal agents PA corresponding to the plurality of users U who are grouped, so that the information is shared among the plurality of personal agents PA and a more optimal advertisement is provided to the group.

The group agent GA receives, from the advertisement distribution apparatus 3, an advertisement provision request for the user U₁, U₂, . . . , Uₘ (Step S5). For example, the advertisement provision request includes type information that indicates information types that are types of one or more pieces of information that are used to select an advertisement, and the group agent GA receives the type information that is included in the advertisement provision request given by the advertisement distribution apparatus 3.

The information type is, for example, a persona of the group, a situation of the group in the chat room, or the like, but embodiments are not limited to this example. The persona of the group includes at least one of various kinds of interests or lack of interests of the group, the number of people in the group, an age group of the group (for example, an age group or an average age group from the youngest to the oldest, or the like), and gender of the group, but embodiments are not limited to this example.

The situation of the group is a type of a topic in the group, a depth of the topic in the group, an atmosphere of the group, a hierarchical relationship of the users U in the group, a degree of intimacy in the group, a degree of humor, or the like, but embodiments are not limited to this example.

Subsequently, the group agent GA makes an inquiry to the plurality of personal agents PA₁, PA₂, . . . , PAₘ of the plurality of users U₁, U₂, . . . , Uₘ who belong to the group A about information corresponding to the type information that is received at Step S5 as predetermined information that is used to provide an advertisement to the group A (Steps S6₁, S6₂, . . . , S6ₘ).

When the information type that is indicated by the type information is the persona of the group, the predetermined information is, for example, information on each of the users U₁, U₂, . . . , Uₘ. When the information type that is indicated by the type information is the persona of the group, the group agent GA makes an inquiry to the corresponding personal agent PA among the personal agents PA₁, PA₂, . . . , PAₘ about the information on each of the users U₁, U₂, . . . , Uₘ as the predetermined information.

The information on each of the users U₁, U₂, . . . , Uₘ is, for example, attribute information that indicates an attribute of each of the users U₁, U₂, . . . , Uₘ, behavior pattern information that indicates a behavior pattern of each of the users U₁, U₂, . . . , Uₘ, or the like, but embodiments are not limited to this example. The attribute of the user U is, for example, a demographic attribute, a psychographic attribute, or the like. The demographic attribute is a demographic attribute of the user U.

The psychographic attribute is, for example, an attribute that indicates an interest, values, a lifestyle, a character, or the like of the user U. The behavior pattern of the user U is, for example, a behavior pattern of each of the users U in an online environment, but may include a behavior pattern of each of the users U in an offline environment.

When the information type that is indicated by the type information is the situation of the group, the predetermined information is, for example, a message history of each of the users U₁, U₂, . . . , Uₘ. When the information type that is indicated by the type information is the situation of the group, the group agent GA makes an inquiry to the corresponding personal agent PA among the personal agents PA₁, PA₂, . . . , PAₘ about the message history of each of the users U₁, U₂, . . . , Uₘ as the predetermined information.

Meanwhile, when the information type that is indicated by the type information is the persona of the group, the predetermined information may be the message history of the user U in addition to or instead of the information on the user U. Furthermore, when the information type that is indicated by the type information is the situation of the group, the predetermined information may be the information on the user U in addition to or instead of the message history of the user U.

The personal agents PA₁, PA₂, . . . , PAₘ generate pieces of answer information that indicate answers to the inquiry that is made by the group agent GA, and outputs the pieces of generated answer information to the group agent GA (Step S7₁, S7₂, . . . , S7ₘ).

Each of the personal agents PA has the information on the user U or the message history, and generates the answer information based on the information on the user U or the message history. For example, when the predetermined information is the information on the user U, each of the personal agents PA generates the information on the user U as the answer information. Furthermore, when the predetermined information is the message history of the user U, each of the personal agents PA generates the message history of the user U as the answer information.

Each of the personal agents PA has, for example, for each type of the service, answer possibility information that indicates whether or not an answer is possible for each type of the predetermined information, and the answer possibility information is set by, for example, the user U of the terminal apparatus 2 that includes each of the personal agents PA.

The type of the predetermined information includes, for example, the information on the user U and the message history, but it may be possible to further subdivide the type. For example, when the predetermined information is the information on the user U, the type of the predetermined information may be various kinds of attributes of the user U (for example, an age group (age), gender, a place of residence, an occupation), various kinds on interests or lack of interests of the user U (for example, a travel lover, a vehicle lover, or the like), or the like, or it may be possible to further subdivide the type.

Furthermore, when the predetermined information is the message history of the user U, the type of the predetermined information may be, for example, a message history of the user U in a chat room of the group A, a message history of the user U in a chat room of a group to which the user U belongs and which is different from the group A, a message history of the user U for which provision is allowed by the user U, or a message history of the user U other than a message history for which provision is not allowed by the user U, or it may be possible to further subdivide the type.

Each of the personal agents PA generates the answer information that includes information of a certain type, for which setting indicating that an answer is possible is made in the information on the user U, when the answer possibility information includes setting indicating that an answer is possible with respect to the type of the predetermined information, and generates the answer information indicating that the answer is impossible in other cases.

Each of the personal agents PA may make an inquiry to the user U if it is possible to provide the answer information, and provide the answer information based on an answer that is given by the user U. For example, when the user U permits to provide the answer information, the personal agent PA provides the answer information.

Each of the personal agents PA may include, for each type of the service, inquiry necessity information that indicates necessity of an inquiry to the user U for each type of the predetermined information, for example. The inquiry necessity information is set by, for example, the user U of the terminal apparatus 2 that includes the personal agent PA.

The group agent GA may make an inquiry to the personal agents PA₁, PA₂, . . . , PAₘ about the predetermined information while adopting information that includes pieces of information on the personal agents PA₁, PA₂, . . . , PAₘ and information on the personal agent PA₁ that transmits the answer information as inquiry information, in addition to the predetermined information.

In this case, the personal agent PA₁ may collect pieces of answer information from the personal agent PA₂, . . . , PAₘ and output the pieces of collected answer information to the group agent GA together with the answer information of the personal agent PA₁.

The group agent GA generates advertisement selection information that is information used to select an advertisement that is to be provided to the group A, by using the answer information that is provided by each of the personal agents PA₁, PA₂, . . . , PAₘ at Steps S7₁, S7₂, . . . , S7ₘ in response to the inquiries that are made at Steps S6₁, S6₂, . . . , S6ₘ (Step S8).

When the information type that is indicated by the type information is the persona of the group, the group agent GA estimates information that indicates the persona of the group A. When the answer information is attribute information on each of the users U₁, U₂, . . . , Uₘ in the group A, the group agent GA determines, as the persona of the group A, various kinds of interests or lack of interests of the group A, the number of people in the group A, an age group of the group A (for example, an age group or an average age group from the youngest to the oldest, or the like), gender of the group, or the like.

The group agent GA may adopt a common interest among the plurality of users U₁, U₂, . . . , Uₘ as the interest of the group or may adopt an interest that a large percentage of the plurality of users U₁, U₂, . . . , Uₘ have as the interest of the group.

Furthermore, the group agent GA is able to estimate the persona of the group by using generative Artificial Intelligence (AI). The generative AI is, for example, text generative AI. The text the generative AI is, for example, Large Language Models that are trained to estimate and output a next token from an input token string, and is, for example, a transformer-based model, a Recurrent Neural Network (RNN)-based model, or the like.

Examples of the transformer-based model include a Generative Pre-trained Transformer (GPT) and gemini, but embodiments are not limited to this example. Examples of the RNN-based model include a Receptance Weighted Key Value (RWKV), but embodiments are not limited to this example.

Meanwhile, the generative AI may be a language model that is trained (for example, fine-tuning) exclusively for generating answer information. The generative AI is arranged in an external information processing apparatus, and the group agent GA uses the generative AI via an API; however, the generative AI may be arranged in the information processing apparatus 1.

The group agent GA is able to input, as input information, information that includes the answer information given by each of the personal agents PA and instruction information to the generative AI, and cause the generative AI to output information that indicates the persona of the group A.

The instruction information includes, for example, a sentence for instructing estimation of the persona of the group A. For example, when the answer information is the information on the user U, the instruction information is information on a character string of “Please estimate a persona of a group of users based on given information on each of the users.”, but embodiments are not limited to this example.

Meanwhile, the instruction information may include information that indicates exemplary associations between exemplary information on the plurality of users U and exemplary personas, which makes it possible to cause the generative AI to estimate the persona with accuracy. Furthermore, the generative AI may be generative AI that is trained by fine tuning or the like by using a data set of pieces of information on the plurality of users U and the personas, and, in this case, input information that is input to the generative AI need not always include the instruction information.

When the type information is the situation of the group A in the chat room, the group agent GA estimates the persona of the group A. For example, the group agent GA may input, as the input information, information that includes the answer information that is given by each of the personal agents PA and instruction information to the generative AI, and cause the generative AI to output information that indicates the situation of the group A in the chat room.

The instruction information includes, for example, a sentence for instructing estimation of the situation of the group A in the chat room. For example, when the answer information is the information on the user U, the instruction information is information on a character string of “Please estimate a situation of a group in a chat room based on a given message history of each of users in the chat room.”, but embodiments are not limited to this example.

Meanwhile, the instruction information may include information that indicates exemplary associations between exemplary message histories of the plurality of users U and exemplary situations, which makes it possible to cause the generative AI to estimate the situation with accuracy. Furthermore, the generative AI may be generative AI that is trained by fine tuning or the like by using a data set of the message histories of the plurality of users U and the situations, and, in this case, the input information that is input to the generative AI need not always include the instruction information.

The group agent GA generates the advertisement selection information based on the estimated persona of the group. For example, the group agent GA generates information that indicates the estimated persona of the group as the advertisement selection information or generates a part of the information that indicates the estimated persona of the group as the advertisement selection information.

Furthermore, the group agent GA generates the advertisement selection information based on the estimated situation. For example, the group agent GA generates information that indicates the estimated situation of the group in the chat room as the advertisement selection information or generates a part of the information that indicates the estimated situation of the group in the chat room as the advertisement selection information.

The group agent GA provides the advertisement selection information that is generated at Step S8 to an advertisement provider (Step S9). At Step S9, the group agent GA transmits the advertisement selection information that is generated at Step S8 to the advertisement distribution apparatus 3 that has transmitted the advertisement provision request that is received at Step S5, and provides the advertisement selection information to the advertisement provider.

The group agent GA provides an advertisement, which is provided by the advertisement provider in response to the provision of the advertisement selection information, to the group (Step S10). At Step S10, the group agent GA receives the advertisement that is provided by the advertisement distribution apparatus 3 in response to the provision of the advertisement selection information, transmits the received advertisement to the terminal apparatuses 2₁, 2₂, . . . , 2ₘ of the users U₁, U₂, . . . , Uₘ who belong to the group A, and provides the advertisement, which is provided by the advertisement distribution apparatus 3, to the group A.

The terminal apparatuses 2₁, 2₂, . . . , 2ₘ, when receiving the advertisement from the group agent GA, displays the received advertisement as a chat message in the chat room of the group chat.

Furthermore, the terminal apparatuses 2₁, 2₂, . . . , 2ₘ may display the received advertisement in the chat room in a different format from the chat message, or display the received advertisement in a pop-up window that is superimposed on the chat room.

In the example illustrated in (b) in FIG. 1, in the chat room of the group A in the terminal apparatus 2₁, an advertisement CTA1, an advertisement CTA2, an advertisement CTM_A1, and an advertisement CTM_A2 are displayed. The advertisement CTA1 and the advertisement CTM_A1 are advertisements of DDD Chinese food, and the advertisement CTA2 and the advertisement CTM_A2 are advertisements of FFF Sichuan food.

The advertisement CTM_A1 and the advertisement CTM_A2 are advertisements in message formats, and included in a chat message CTM5. The advertisement CTM_A1 and the advertisement CTM_A2 are displayed in the same display mode as the display mode of the chat message in the screen of the group chat. The advertisement CTA1 and the advertisement CTA2 are advertisements in a banner format that includes an image, text, and a link.

In this manner, the information processing apparatus 1 makes an inquiry to the plurality of personal agents PA each of which is associated with a corresponding user U among the plurality of users U who are grouped about information that is used to provide an advertisement to the group corresponding to the plurality of users U, generates the advertisement selection information that is information that is used to select an advertisement by using information that is provided by the plurality of personal agents PA in response to the inquiry, and provides the generated advertisement selection information to the advertisement provider. With this configuration, the information processing apparatus 1 is able to provide a more appropriate advertisement to the users U in the chat group.

A configuration of the information processing system that includes the information processing apparatus 1 and the terminal apparatuses 2₁ to 2ₘ that perform the above-described process will be described in detail below.

### 2. Configuration of Information Processing System

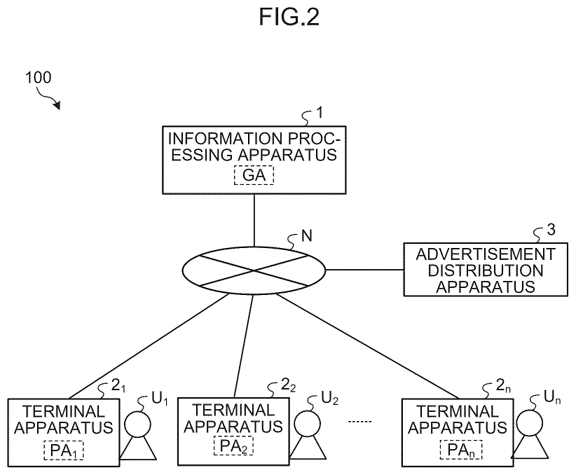

FIG. 2 is a diagram illustrating an example of a configuration of an information processing system according to one embodiment. As illustrated in FIG. 2, an information processing system 100 according to one embodiment includes the information processing apparatus 1, the plurality of terminal apparatuses 2₁, 2₂, . . . , 2ₙ, and the advertisement distribution apparatus 3. n is, for example, an integer equal to or larger than m as described above.

The plurality of terminal apparatuses 2₁, 2₂, . . . , 2ₙ are used by the different users U₁, U₂, . . . , Uₙ. The terminal apparatuses 2₁, 2₂, . . . , 2ₙ are, for example, notebook PCs, desktop PCs, smartphones, tablet PCs, wearable devices, or the like. The wearable device is, for example, smart glasses, a smart watch, or the like, but embodiments are not limited to this example.

The information processing apparatus 1, the terminal apparatuses 2₁, 2₂, . . . , 2ₙ, and the advertisement distribution apparatus 3 are communicably connected to one another in a wired or wireless manner via the network N. Meanwhile, the information processing system 100 illustrated in FIG. 2 may include the plurality of information processing apparatuses 1 and the plurality of advertisement distribution apparatuses 3, for example.

The network N includes, for example, a Wide Area Network, such as the Internet, a mobile communication network, such as Long Term Evolution (LTE), 4th Generation Mobile Communication System (4G), or 5th Generation Mobile Communication System (5G).

The terminal apparatus 2 is able to connect to the network N via a near field wireless communication, such as a mobile communication network, Bluetooth (registered trademark), or a wireless Local Area Network (LAN), and communicate with the information processing apparatus 1 and the advertisement distribution apparatus 3.

### 3. Configuration of Information Processing Apparatus 1

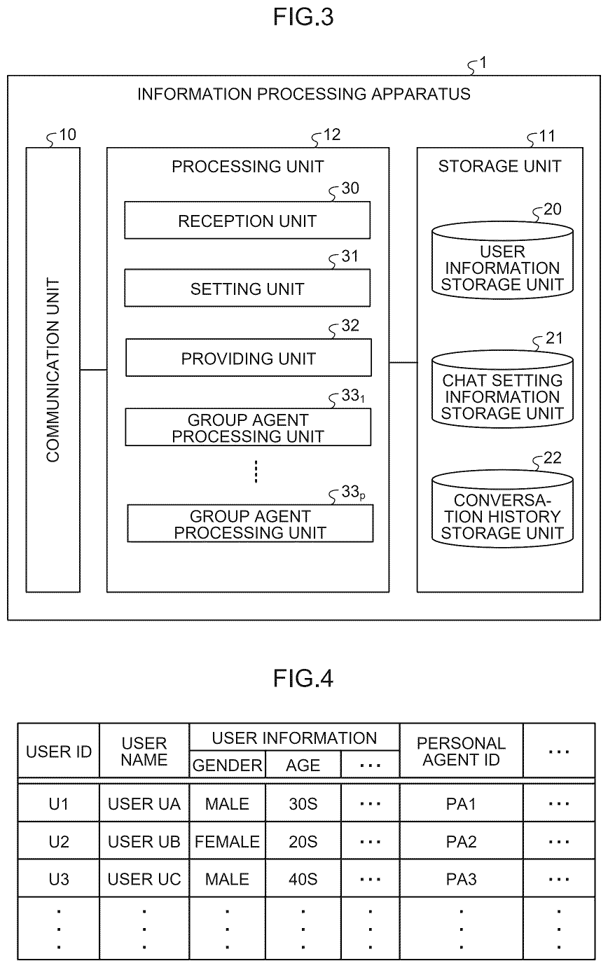

FIG. 3 is a diagram illustrating an example of a configuration of the information processing apparatus 1 according to one embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a Network Interface Card (NIC), or the like. Further, the communication unit 10 is connected to the network N in a wired or wireless manner and transmits and receives information to and from various kinds of different apparatuses. For example, the communication unit 10 transmits and receives information to and from the terminal apparatus 2 via the network N.

### 3.2. Storage Unit 11

The storage unit 11 is implemented by, for example, a semiconductor memory device, such as a Random Access Memory (RAM) or a Flash Memory, or a storage device, such as a hard disk or an optical disk. The storage unit 11 includes a user information storage unit 20, a chat setting information storage unit 21, and a conversation history storage unit 22.

### 3.2.1. User Information Storage Unit 20

The user information storage unit 20 stores therein user information including information on the user U. FIG. 4 is a diagram illustrating an example of a user information table that is stored in the user information storage unit 20 of the information processing apparatus 1 according to one embodiment. As illustrated in FIG. 4, the user information table that is stored in the user information storage unit 20 includes items of a “user ID”, a “user name”, “user information”, a “personal agent ID”, and the like.

The “user ID” is identification information for identifying the user U and is information that is assigned to each of the users U. The “user name” is a name of the user U corresponding to the “user ID”. The “user information” is attribute information and a behavior history of the user U corresponding to the “user ID”.

The attribute information on the user U includes, for example, information on a psychographic attribute, information on a demographic attribute, or the like. The demographic attribute is, for example, gender, an age, a place of residence, an occupation, or the like, and the psychographic attribute is a subject of interest, such as a travel, clothes, a vehicle, or a religion, a lifestyle, a thought, a tendency of thought, or the like.

The behavior history of the user U is a behavior history of the user U in an online service and a behavior of the user in an offline environment. The behavior history of the user U in the online service includes, for example, information on a search history, a browsing history, a post history, a purchase history, or the like.

The search history is information on a search query that was used by the user U in the past and a content that was viewed by the user U from among search results. The information on the search query is, for example, information on a search keyword, a search phrase, or the like.

The browsing history includes, for example, information that indicates a content that is viewed by the user U in the online service, and the post history includes, for example, information that indicates a content (for example, a review, a comment, or the like) that was posted in the past by the user U in the online service. The purchase history includes information on a business counterparty with whom the user U made a deal in the past.

The behavior history of the user U in an offline environment includes, for example, a movement history of the user U in an offline environment, a usage history (including a purchase history of a product or a service) of the user U in a real store, or the like, but embodiments are not limited to this example.

The “personal agent ID” is identification information for identifying the personal agent PA of the user U corresponding to the “user ID”, and is information that is assigned to each of the personal agents PA. The personal agent PA is a service agent for each of the users U as described above, and may be, for example, Auto-GPT or the like.

### 3.2.2. Chat Setting Information Storage Unit 21

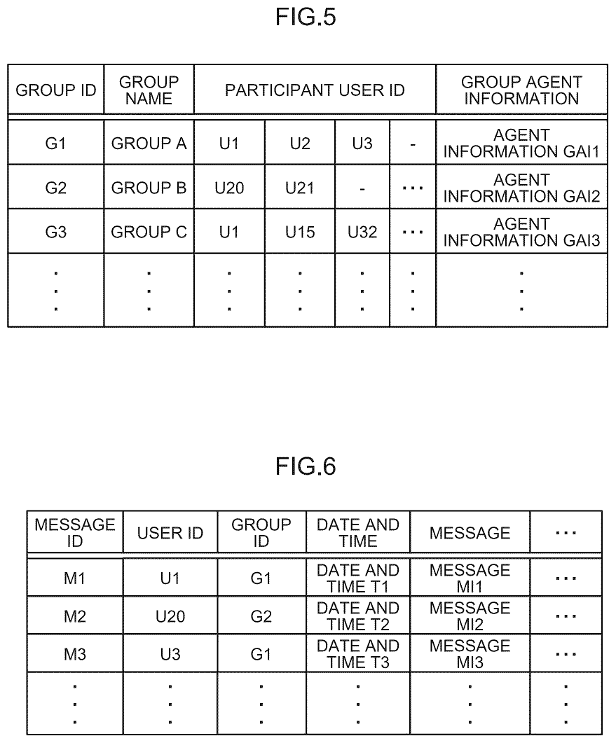

The chat setting information storage unit 21 stores therein various kinds of setting information for a chat service. FIG. 5 is a diagram illustrating an example of a chat setting information table that is stored in the chat setting information storage unit 21 of the information processing apparatus 1 according to one embodiment.

As illustrated in FIG. 5 the chat setting information table that is stored in the chat setting information storage unit 21 includes items of a “group ID”, a “group name”, a “participant user ID”, “group agent information”, and the like.

The “group ID” is an identifier for identifying a chat group and is information that is assigned to each of the chat groups. The “group name” is information that indicates a name of the chat group that is associated with the “group ID”.

The “participant user ID” includes a user ID of each of the users U who participates in the chat group that is associated with the “group ID”. The “group agent information” is information on the group agent GA of the chat group that is associated with the “group ID”, and includes an agent ID, setting information, stored information, or the like of the group agent GA. The group agent GA is, for example, a service agent for each of the groups, and may be, for example, Auto-GPT or the like. Further, the group agent GA may be, for example, a service agent that is assigned to a plurality of groups.

Meanwhile, for example, the chat setting information table illustrated in FIG. 6 includes, as the setting information other than the chat group, setting information on a one-to-one chat, setting information on a one-to-many chat, or the like, although not illustrated in the drawing.

### 3.2.3. Conversation History Storage Unit 22

The conversation history storage unit 22 stores therein various kinds of conversation histories in the chat service. FIG. 6 is a diagram illustrating an example of a conversation history table that is stored in the conversation history storage unit 22 of the information processing apparatus 1 according to one embodiment. As illustrated in FIG. 6, the conversation history table that is stored in the conversation history storage unit 22 includes items of a “message ID”, a “user ID”, a “group ID”, “date and time”, a “message”, and the like.

The “message ID” is an identifier for identifying a chat message, and is information that is assigned to each of chat messages. The “user ID” is a user ID of the user U who has posted the chat message corresponding to the “message ID”. The “group ID” is a group ID of a chat group corresponding to a chat room in which the chat message corresponding to the “message ID” is posted.

The “date and time” is information that indicates a date and time at which the chat message corresponding to the “message ID” is posted. The “message” is the chat message corresponding to the “message ID”. Meanwhile, for example, the chat setting information table illustrated in FIG. 6 includes, as the conversation history other than the chat group, a conversation history in a one-to-one chat, a conversation history in a one-to-many chat, or the like, although not illustrated in the drawing.

### 3.3. Processing Unit 12

The processing unit 12 is a controller, and implemented by, for example, causing a processor, such as a Central Processing Unit (CPU) or a Micro Processing Unit (MPU), to execute various kinds of programs (corresponding to one example of an information processing program) that are stored in a storage device in the information processing apparatus 1 by using a RAM or the like as a work area.

Further, the processing unit 12 is a controller, and may be implemented by, for example, an integrated circuit, such as an Application Specific Integrated Circuit (ASIC), a Field Programmable Gate Array (FPGA), or a General Purpose Graphic Processing Unit (GPGPU).

As illustrated in FIG. 3, the processing unit 12 includes a reception unit 30, a setting unit 31, a providing unit 32, and group agent processing units 33₁ to 33ₚ and implements or performs functions and operation of information processing as described below. p indicates the number of group agents and is an integer equal to or larger than two.

Meanwhile, an internal configuration of the processing unit 12 is not limited to the configuration as illustrated in FIG. 3, and it is possible to adopt a different configuration as long as the information processing to be described below is performed. Further, in the following, when each of the group agent processing units 33₁ to 33ₚ is described without being individually distinguished, each of the group agent processing units 33₁ to 33ₚ may be described as a group agent processing unit 33.

### 3.3.1. Reception Unit 30

The reception unit 30 receives various kinds of information. For example, the reception unit 30 receives a post request that is transmitted from the terminal apparatus 2. The post request includes information on a chat message, a group ID, a user ID, or the like. The reception unit 30 updates the conversation history table that is stored in the conversation history storage unit 22 based on the post request.

Furthermore, the reception unit 30 receives a chat group setting request that is transmitted from the terminal apparatus 2. The chat group setting request is a request for setting to form a group of the plurality of users U for a group chat among the plurality of users U, and includes user IDs of the plurality of users U who are grouped, a name of the group, or the like.

Moreover, the reception unit 30 receives a user addition request that is transmitted from the terminal apparatus 2. The user addition request includes the group ID and a user ID of the user U who is added from the group among the plurality of users U who are grouped as the group with the group ID.

Furthermore, the reception unit 30 receives a user delete request that is transmitted from the terminal apparatus 2. The user addition request includes the group ID and a user ID of the user U who is excluded to the group among the plurality of users U who are grouped in the group with the group ID.

### 3.3.2. Setting Unit 31

When the reception unit 30 receives a group setting request, the setting unit 31 sets group information that is included in the group setting request based on the group setting request. The group information includes a group ID, a group name, a participant user ID, and group agent information.

For example, the setting unit 31 adds the group information to the chat setting information table that is stored in the chat setting information storage unit 21 based on the chat group setting request that is received by the reception unit 30.

Furthermore, the setting unit 31 updates the group information in the chat setting information table based on the user addition request that is received by the reception unit 30. Moreover, the setting unit 31 updates the group information in the chat setting information table based on the user delete request that is received by the reception unit 30.

### 3.3.3. Providing Unit 32

The providing unit 32 provides various kinds of information. For example, the providing unit 32 transmits a chat message that is included in the post request that is received by the reception unit 30 to the terminal apparatus 2 which is different from the terminal apparatus 2 that has transmitted the post request and which is the terminal apparatus 2 of the user U to whom the chat message is transmitted.

### 3.3.4. Group Agent Processing Unit 33

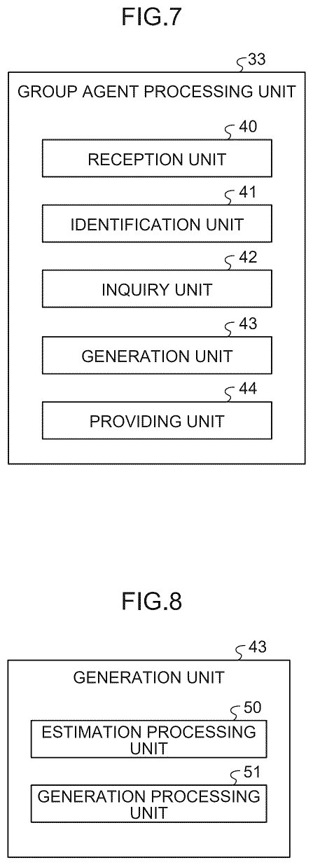

The group agent processing unit 33 implements functions of the group agent. FIG. 7 is a diagram illustrating an example of a configuration of the group agent processing unit 33 in the processing unit 12 of the information processing apparatus 1 according to one embodiment.

As illustrated in FIG. 7, the group agent processing unit 33 includes a reception unit 40, an identification unit 41, an inquiry unit 42, a generation unit 43, and a providing unit 44. Each of the reception unit 40, the identification unit 41, the inquiry unit 42, the generation unit 43, and the providing unit 44 will be described in detail below.

### 3.3.4.1. Reception Unit 40

The reception unit 40 receives various kinds of information. The reception unit 40 receives the advertisement provision request for the group from the advertisement distribution apparatus 3. The advertisement provision request is transmitted from the advertisement distribution apparatus 3 and received and accepted by the reception unit 40 via the communication unit 10.

The advertisement provision request includes, for example, type information that indicates information types that are types of one or more pieces of information that are used to select an advertisement. The reception unit 40 receives, as a designation of the type information that is used to provide an advertisement to the group, the type information that is included in the advertisement provision request that is given by the advertisement distribution apparatus 3.

Furthermore, the reception unit 40 may receive designation of the type information that is included in a request that is transmitted by a different apparatus from the advertisement distribution apparatus 3, or may receive designation of type information that is made by an operator of the information processing apparatus 1.

Examples of the information type that is indicated by the type information include the persona of the group and the situation of the group in the chat room, but embodiments are not limited to this example. The persona of the group includes at least one of various kinds of interests or lack of interests of the group, the number of people in the group, an age group of the group (for example, an age group or an average age group from the youngest to the oldest, or the like), and gender of the group, but embodiments are not limited to this example.

The situation of the group is a type of a topic in the group, a depth of the topic in the group, an atmosphere of the group, a hierarchical relationship of the users U in the group, a degree of intimacy in the group, a degree of humor, or the like, but embodiments are not limited to this example.

### 3.3.4.2. Identification Unit 41

The identification unit 41 performs various kinds of identification. The identification unit 41 identifies a plurality of personal agents PA each of which is associated with a corresponding user U among the plurality of users U who are grouped.

The identification unit 41 identifies, as a personal agent PA of the user U, the personal agent PA of a chat application in which the user ID of the user U is set. The user ID is an account of the user U, which is set in the chat application.

For example, the identification unit 41 identifies, as the personal agent PA₁, a personal agent of the chat application in which the user ID of the user U₁ is set and which operates on the terminal apparatus 2₁. Further, the identification unit 41 identifies, as the personal agent PA₂, a personal agent of the chat application in which the user ID of the user U₂ is set and which operates on the terminal apparatus 2₂.

Furthermore, the identification unit 41 identifies, s the personal agent PAₘ, a personal agent of the chat application in which the user ID of the user Uₘ is set and which operates on the terminal apparatus 2ₘ.

The personal agent PA is one of functions that are included in the chat application, and functions as an agent for the user U. For example, the personal agent PA₁ functions as an agent for the user U₁, the personal agent PA₂ functions as an agent for the user U₂, and the personal agent PAₘ functions as an agent for the user Uₘ.

The identification unit 41 identifies the plurality of personal agents PA of the plurality of users U who are grouped, for each of the groups, based on the user information table that is stored in the user information storage unit 20 and the chat setting information table that is stored in the chat setting information storage unit 21.

When the user information table is in the state as illustrated in FIG. 4 and the chat setting information table is in the state as illustrated in FIG. 5, the user IDs of the plurality of users U who are grouped as the group A are “U1”, “U2”, and “U3”. Therefore, the identification unit 41 identifies, as the personal agents PA of the group A, personal agents PA₁, PA₂, and PA₃ with personal agent IDs of PA1, PA2, and PA3.

### 3.3.4.3. Inquiry Unit 42

The inquiry unit 42 makes various kinds of inquiries to the personal agent PA.

The inquiry unit 42 makes an inquiry to the plurality of personal agents that are identified by the identification unit 41 about predetermined information that corresponds to the information type that is indicated by the type information. The predetermined information is, as described above, information that is used to provide an advertisement to a group corresponding to the plurality of users U and is information that corresponds to the information type.

For example, when the information type that is indicated by the type information is the persona of the group, the predetermined information is, for example, information on each of the users U who belong to the group. When the information type that is indicated by the type information is the persona of the group, the inquiry unit 42 makes an inquiry to the corresponding personal agent PA among the plurality of personal agents PA about the information on each of the users U who belong to the group as the predetermined information.

The information on the user U is, for example, attribute information that indicates the attribute of the user U, behavior pattern information that indicates a behavior pattern of the user U, or the like, but embodiments are not limited to this example. The attribute of the user U is, for example, a demographic attribute, a psychographic attribute, or the like. The demographic attribute is a demographic attribute of the user U.

The psychographic attribute is, for example, an attribute that indicates an interest, values, a lifestyle, a character, or the like of the user U. The behavior pattern of the user U is, for example, a behavior pattern of each of the users U in an online environment, but may include a behavior pattern of each of the users U in an offline environment.

When the information type that is indicated by the type information is the situation of the group, the predetermined information is, for example, the message history of each of the users U. When the information type that is indicated by the type information is the situation of the group, the inquiry unit 42 makes an inquiry to the corresponding personal agent PA among the personal agents about the message history of each of the users U as the predetermined information.

Meanwhile, when the information type that is indicated by the type information is the persona of the group, the predetermined information may be the message history of the user U in addition to or instead of the information on the user U. Furthermore, when the information type that is indicated by the type information is the situation of the group, the predetermined information may be the information on the user U in addition to or instead of the message history of the user U.

In the terminal apparatus 2, the personal agent PA has the information on the user U or the message history, and generates the answer information based on the information on the user U or the message history. For example, when the predetermined information is the information on the user U, the personal agent PA generates the information on the user U as the answer information. Furthermore, when the predetermined information is the message history of the user U, the personal agent PA generates the message history of the user U as the answer information.

The personal agent PA has, for example, for each type of the service, answer possibility information that indicates whether or not an answer is possible for each type of the predetermined information, and the answer possibility information is set by, for example, the user U of the terminal apparatus 2 that includes each of the personal agents PA.

The type of the predetermined information includes, for example, the information on the user U and the message history, but it may be possible to further subdivide the type. For example, when the predetermined information is the information on the user U, the type of the predetermined information may be various kinds of attributes of the user U (for example, an age group (age), gender, a place of residence, an occupation), various kinds on interests or lack of interests of the user U (for example, a travel lover, a vehicle lover, or the like), or the like, or it may be possible to further subdivide the type.

Furthermore, when the predetermined information is the message history of the user U, the type of the predetermined information may be, for example, a message history of the user U in a chat room of a target group, a message history of the user U in a chat room of a group to which the user U belongs and which is different from the target group, a message history of the user U for which provision is allowed by the user U, or a message history of the user U other than a message history for which provision is not allowed by the user U, or it may be possible to further subdivide the type.

The personal agent PA generates the answer information that includes information of a certain type, for which setting indicating that an answer is possible is made in the information on the user U, when the answer possibility information includes setting indicating that an answer is possible with respect to the type of the predetermined information, and generates the answer information indicating that the answer is impossible in other cases.

The personal agent PA may make an inquiry to the user U if it is possible to provide the answer information, and provide the answer information based on an answer that is given by the user U For example, when the user U permits to provide the answer information, the personal agent PA provides the answer information.

The personal agent PA may include, for each type of the service, for example, the inquiry necessity information that indicates necessity of an inquiry to the user U for each type of the predetermined information. The inquiry necessity information is set by, for example, the user U of the terminal apparatus 2 that includes the personal agent PA.

The group agent GA may make an inquiry to the personal agents PA₁, PA₂, . . . , PAₘ about the predetermined information while adopting information that includes pieces of information on the personal agents PA₁, PA₂, . . . , PAₘ that correspond to a specific group and information on the personal agent PA₁ that transmits the answer information as inquiry information, in addition to the predetermined information.

In this case, the personal agent PA₁ may collect pieces of answer information from the personal agent PA₂, . . . , PAₘ and output the pieces of collected answer information to the group agent GA together with the answer information of the personal agent PA₁.

The personal agent PA that provides an answer as a representative is not limited to the personal agent PA₁, and the personal agent PA that provides an answer as a representative may include two or more personal agents PA. For example, when the number of the personal agents PA is large, a single representative personal agent PA may collect pieces of answer information from the other personal agents PA for each group of the personal agents PA, and output the answer information of the group of the personal agents PA to the group agent GA.

In this manner, one or more personal agents PA among the plurality of personal agents PA are able to collect pieces of answer information with respect to an inquiry from the other personal agents PA and output information that includes the piece of collected answer information as answer information with respect to the inquiry to the group agent GA.

Furthermore, the representative personal agent PA may estimate the persona of the group or the situation of the group in the chat room based on the pieces of collected answer information, on behalf of the group agent GA. In this case, the representative personal agent PA outputs, as the answer information, information that indicates the estimated persona of the group or the estimated situation of the group in the chat room to the group agent GA.

### 3.3.4.4. Generation Unit 43

The generation unit 43 generates the advertisement selection information, which is information used to select an advertisement, by using the pieces of answer information that are provided by the plurality of personal agents PA in response to an inquiry that is made by the inquiry unit 42.

FIG. 8 is a diagram illustrating an example of a configuration of the generation unit 43 in the processing unit 12 of the information processing apparatus 1 according to one embodiment. As illustrated in FIG. 8, the generation unit 43 includes an estimation processing unit 50 and a generation processing unit 51.

The estimation processing unit 50 estimates a persona of a group based on pieces of information that are provided by the plurality of personal agents PA in response to an inquiry that is made by the inquiry unit 42. For example, when the information type that is indicated by the type information is the persona of the group, the estimation processing unit 50 estimates the persona of the group. For example, the estimation processing unit 50 estimates, as the persona of the group, a common attribute or a common interest among the plurality of users U.

For example, when the answer information is the attribute information on each of the users U of the group, the estimation processing unit 50 determines, as the persona of the target group, various kinds of interests or lack of interests of the group, t the number of people in the group, an age group of the group (for example, an age group or an average age group from the youngest to the oldest, or the like), gender of the group, or the like.

The estimation processing unit 50 adopt a common interest among the plurality of users U as the interest of the group or may adopt an interest that a large percentage of the plurality of users U have as the interest of the group.

Furthermore, the estimation processing unit 50 is able to estimate the persona of the group by using generative AI. The generative AI is, for example, text generative AI. The text the generative AI is, for example, Large Language Models that are trained to estimate and output a next token from an input token string, and is, for example, a transformer-based model, an RNN-based model, or the like.

Examples of the transformer-based model include a GPT, but embodiments are not limited to this example. Examples of the RNN-based model include an RWKV, but embodiments are not limited to this example.

Meanwhile, it is preferable that the input information conceals information, such as input personal information, by being trained such that the input information is not used as a new answer. Furthermore, the generative AI may be a language model that is trained (for example, fine-tuning) exclusively for generating answer information. The generative AI is arranged in an external information processing apparatus, and the estimation processing unit 50 uses the generative AI via an API; however, the generative AI may be arranged in the information processing apparatus 1.

The estimation processing unit 50 is able to input, as input information, information that includes the answer information given by each of the personal agents PA and instruction information to the generative AI, and cause the generative AI to output information that indicates the persona of the group.

The instruction information includes, for example, a sentence for instructing estimation of the persona of the group. For example, when the answer information is the information on the user U, the instruction information is information on a character string of “Please estimate a persona of a group of users based on given information on each of the users.”, but embodiments are not limited to this example.

Meanwhile, the instruction information may include information that indicates exemplary associations between exemplary information on the plurality of users U and exemplary personas, which makes it possible to cause the generative AI to estimate the persona with accuracy. Furthermore, the generative AI may be generative AI that is trained by fine tuning or the like by using a data set of pieces of information on the plurality of users U and the personas, and, in this case, input information that is input to the generative AI need not always include the instruction information.

Moreover, the estimation processing unit 50 estimates the situation of the group in the chat room by using the generative AI based on message histories of the plurality of users U in the chat room. For example, when the type information is the situation of the group in the chat room, the estimation processing unit 50 estimates the persona of the group.

The estimation processing unit 50 may input, as the input information, information that includes the answer information on each of the personal agents PA and instruction information to the generative AI, and cause the generative AI to output the information that indicates the situation of the group in the chat room, for example.

The instruction information includes, for example, a sentence for instructing estimation of the situation of the group in the chat room. For example, when the answer information is the information on the user U, the instruction information is information on a character string of “Please estimate a situation of a group in a chat room based on a given message history of each of users in the chat room.”, but embodiments are not limited to this example.

Meanwhile, the instruction information may include information that indicates exemplary associations between exemplary message histories of the plurality of users U and exemplary situations, which makes it possible to cause the generative AI to estimate the situation with accuracy. Furthermore, the generative AI may be generative AI that is trained by fine tuning or the like by using a data set of the message histories of the plurality of users U and the situations, and, in this case, the input information that is input to the generative AI need not always include the instruction information.

The generation processing unit 51 generates the advertisement selection information based on the persona of the group that is estimated by the estimation processing unit 50. For example, the generation processing unit 51 generates information that indicates the persona of the group as the advertisement selection information or generates a part of the information that indicates the persona of the group as the advertisement selection information.

Furthermore, the generation processing unit 51 generates the advertisement selection information based on the situation that is estimated by the estimation processing unit 50. For example, the generation processing unit 51 generates information that indicates the situation of the group in the chat room as the advertisement selection information or generates a part of the information that indicates the situation of the group in the chat room as the advertisement selection information.

### 3.3.4.5. Providing Unit 44

The providing unit 44 provides various kinds of information. For example, the providing unit 44 provides the advertisement selection information that is generated by the generation unit 43 to the advertisement provider.

The providing unit 44 transmits, via the communication unit 10, the advertisement selection information that is generated by the generation unit 43 to the advertisement distribution apparatus 3 that has transmitted the advertisement provision request that is received by the reception unit 40, and provides the advertisement selection information to the advertisement provider.

Furthermore, the providing unit 44 provides an advertisement, which is provided by the advertisement provider in response to the provision of the advertisement selection information, to the group. For example, the providing unit 44 receives the advertisement that is provided by the advertisement distribution apparatus 3 in response to the provision of the advertisement selection information, transmits the received advertisement to the terminal apparatuses 2 of the users U who belong to the group via the communication unit 10, and provides the advertisement, which is provided by the advertisement distribution apparatus 3, to the group.

When receiving the advertisement from the providing unit 44, the terminal apparatus 2 displays the received advertisement as a chat message in the chat room of the group. Furthermore, the terminal apparatus 2 may display the received advertisement in the chat room in a different format from the chat message, or display the received advertisement in a pop-up window that is superimposed on the chat room.

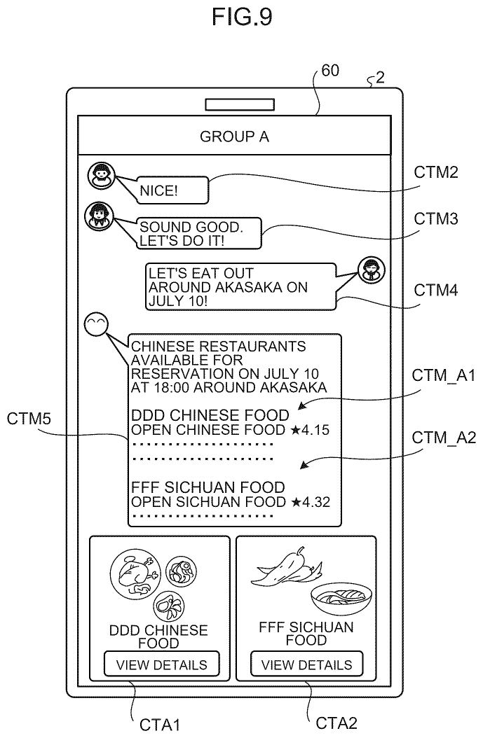

FIG. 9 is a diagram illustrating an example of the advertisement that is provided to the terminal apparatus 2 by the providing unit 44 in the processing unit 12 of the information processing apparatus 1 according to one embodiment, and that is displayed on the terminal apparatus 2. A screen 60 of a chat room illustrated in FIG. 9 is a chat room screen of the group A.

In the example illustrated in FIG. 9, in the chat room of the group A that is displayed on the terminal apparatus 2, the advertisement CTA1, the advertisement CTA2, the advertisement CTM_A1, and the advertisement CTM_A2 are displayed. The advertisement CTA1 and the advertisement CTM_A1 are advertisements of DDD Chinese food, and the advertisement CTA2 and the advertisement CTM_A2 are advertisements of FFF Sichuan food.

The advertisement CTM_A1 and the advertisement CTM_A2 are advertisements in message formats, and included in the chat message CTM5. The advertisement CTM_A1 and the advertisement CTM_A2 are displayed in the same display mode as the display mode of the chat message in the screen of the group chat. The advertisement CTA1 and the advertisement CTA2 are advertisements in a banner format that includes an image, text, and a link.

### 4. Flow of Processes

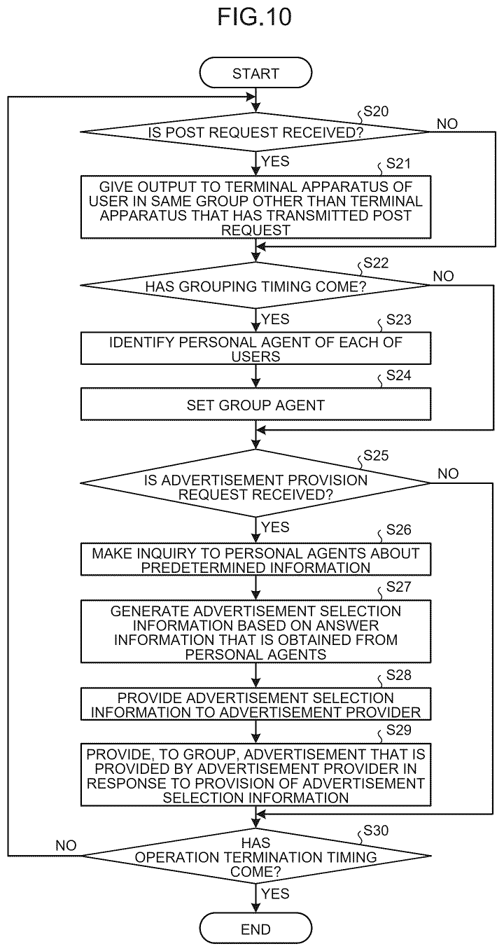

A flow of information processing that is performed by the processing unit 12 of the information processing apparatus 1 according to one embodiment will be described below. FIG. 10 is a flowchart illustrating an example of the information processing that is performed by the processing unit 12 of the information processing apparatus 1 according to one embodiment.

As illustrated in FIG. 10, the processing unit 12 of the information processing apparatus 1 determines whether or not a post request is received (Step S20). When it is determined that the post request is received (Step S20: Yes), the processing unit 12 transmits a chat message that is included in the post request to the terminal apparatuses 2 of the users U in the same group other than the terminal apparatus 2 that has transmitted the post request (Step S21).

Subsequently, when the process at Step S21 is terminated or when it is determined that the post request is not received (Step S20: No), the processing unit 12 determines whether or not a grouping timing has come (Step S22). The processing unit 12 determines that the grouping timing has come when, for example, receiving the chat group setting request.

When it is determined that the grouping timing has come (Step S22: Yes), the processing unit 12 identifies the personal agent PA of each of the users U who are grouped (Step S23), and sets the group agent GA of the group (Step S24).

When the process at Step S21 is terminated or when it is determined that the grouping timing has not yet come (Step S22: No), the processing unit 12 determines whether or not an advertisement provision request is received (Step S25).

When it is determined that the advertisement provision request is received (Step S25: Yes), the processing unit 12 makes an inquiry to the plurality of personal agents PA about the predetermined information (Step S26). Further, the processing unit 12 generates advertisement selection information based on answer information that is obtained from the plurality of personal agents PA (Step S27), and provides the generated advertisement selection information to the advertisement provider (Step S28). The processing unit 12 provides, to the group, an advertisement that is provided by the advertisement provider in response to provision of the advertisement selection information at Step S28 (Step S29).

When the process at Step S29 is terminated or when it is determined that the advertisement provision request is not received (Step S25: No), the processing unit 12 determines whether or not an operation termination timing has come (Step S30). The processing unit 12 determines that the operation termination timing has come when, for example, the power supply of the information processing apparatus 1 is turned off.

When the processing unit 12 determines that the operation termination timing has not yet come (Step S30: No), the process goes to Step S20, and when the processing unit 12 determines that the operation termination timing has come (Step S30: Yes), the process illustrated in FIG. 10 is terminated.

### 5. Modifications

The chat group has been described above as an example of the group of the users U, but the processing unit 12 of the information processing apparatus 1 is able to perform the same processes for a group other than the chat group.

A part or all of the functions of the advertisement distribution apparatus 3 as described above may be implemented by the information processing apparatus 1. For example, the information processing apparatus 1 may be configured to include a part or whole of the advertisement distribution apparatus 3 as described above, instead of the information processing apparatus 1.

Furthermore, a part or all of the functions of the information processing apparatus 1 as described above may be implemented by one of the terminal apparatuses 2 of the plurality of users U who are included in the group. For example, the terminal apparatus 2 may be configured to include a part or whole of the information processing apparatus 1 as described above, instead of the terminal apparatus 2.

Moreover, the setting unit 31 may set the answer possibility information and the inquiry necessity information based on the attribute information on the user U. With this configuration, the answer possibility information and the inquiry necessity information are set in accordance with the attribute of the user U.

Furthermore, in the example as described above, the processing unit 12 of the information processing apparatus 1 makes an inquiry to the plurality of personal agents that are associated with the plurality of users U who are grouped about information that is used to provide an advertisement to the group, but embodiments are not limited to this example.

For example, the identification unit 41 of the processing unit 12 acquires information on each of the users U or a conversation history or the like in the chat group from the storage unit 11 or an external server, and identifies a characteristic of each of the users U or a relationship between the users U in the group based on the acquired information on each of the users U or the acquired conversation history or the like in the chat group.

Examples of the characteristic of the user U include the attribute of the user U and the behavior pattern of the user U. Examples of the attribute of the user U include a demographic attribute and a psychographic attribute. Examples of the behavior pattern of the user U include a purchase behavior pattern, a movement pattern, and a web search pattern, but embodiments are not limited to this example.

The relationship between the users U is, for example, a parent-child relationship, a colleague relationship, a boss-subordinate relationship, a friendship, a teacher-student relationship, or the like. The friendship includes a friendship in a Social Networking Service (SNS), a friendship based on same hobbies, a friendship in an online game, or the like, but embodiments are not limited to this example. Furthermore, the relationship between the users U includes a degree of intimacy, a reliability, dependency, a communication frequency, a degree of influence, a physical degree (a physical distance), or the like.

The identification unit 41 identifies the relationship between the users U in the group based on, for example, a conversation history that is a history of chat messages between the users U. Further, the identification unit 41 is able to identify the relationship between the users U in the group based on, for example, the attribute of each of the users U in the group, in addition to or instead of the conversation history.

The identification unit 41 may input, as the input information, information that includes the history of chat messages between the users U and instruction information for instructing identification of the relationship between the users U to the generative AI, and may cause the generative AI to output an identification result of the relationship between the users U, for example.

In this case, the instruction information is, for example, information on a character string of “Please identify a relationship between users from a given history of chat messages between the users.” or the like, but embodiments are not limited to this example. The instruction information may include exemplary information on a combination of a relationship list, an exemplary message history, and an exemplary relationship, or the like.

The generation processing unit 51 of the generation unit 43 generates the advertisement selection information based on characteristics of the users U or the relationship between the users U in the group that is identified by the identification unit 41. For example, the generation processing unit 51 generates, as the advertisement selection information, information that indicates the characteristic of each of the users U or the relationship between the users U in the group, or generates, as the advertisement selection information, a part of the information that indicates the characteristic of each of the users U or the relationship between the users U in the group.

Furthermore, the generation processing unit 51 may generate the advertisement selection information based on the characteristic of each of the users U or the relationship between the users U in the group that is identified by the identification unit 41, and based on the situation that is estimated by the estimation processing unit 50.

For example, the generation processing unit 51 may generate, as the advertisement selection information, information that indicates the situation of the group in the chat room, information that indicates the characteristic of each of the users U, and information that indicates the relationship between the users U in the group, or may generate, as the advertisement selection information, a part of the above-described information.

Furthermore, the providing unit 44 may determine whether or not to provide the advertisement selection information to the advertisement provider based on at least one of the information that indicates the situation of the group in the chat room, the information that indicates the characteristic of each of the users U, and the information that indicates the relationship between the users U in the group. When the providing unit 44 determines that the advertisement selection information is not to be provided to the advertisement provider, the generation unit 43 need not always generate the advertisement selection information.

Moreover, the advertisement selection information is not limited to the information as described above. The generation processing unit 51 may generate, as the advertisement selection information, information that indicates a type of an advertisement, instead of the information as described above. For example, the generation processing unit 51 generates, as the advertisement selection information, information that indicates a type of an advertisement based on at least one of the information that indicates the situation of the group in the chat room, the information that indicates the characteristic of each of the users U, and the information that indicates the relationship between the users U in the group.

For example, the generation processing unit 51 may input, as the input information, information that includes at least one of the information that indicates the situation of the group in the chat room, the information that indicates the characteristic of each of the users U, and the information that indicates the relationship between the users U in the group and instruction information for instructing identification of a type of an appropriate advertisement from the above-described information to the generative AI, and cause the generative AI to generates information that indicates the type of the advertisement.

In this case, the instruction information is, for example, information on a character string of “Please output one type of an advertisement for which an advertising effectiveness is high among advertisements to be provided to the group, based on a given situation of the group in the chat room, a given characteristic of each of the users U in the group, and a given relationship between the users U in the group.” or the like, but embodiments are not limited to this example. The information that indicates the type of the advertisement, which is to be output by the generative AI, may be information that indicates types of a plurality of advertisements. Meanwhile, the instruction information may include exemplary information on combinations of examples of the situation of the group, the characteristic of each of the users U in the group, and the relationship between the users U in the group and exemplary types of the advertisements.

Furthermore, the generation processing unit 51 may have an advertisement type correspondence list that include information that indicates types of one or more advertisements for each content of at least one of the information that indicates the situation of the group in the chat room, the information that indicates the characteristic of each of the users U, and the information that indicates the relationship between the users U in the group, identify the type of the advertisement based on the advertisement type correspondence list, and generate information that indicates the identified type of the advertisement as the advertisement selection information.

In this manner, the generation processing unit 51 is able to identify the type of the advertisement based on at least one of the information that indicates the situation of the group in the chat room, the information that indicates the characteristic of each of the users U, and the information that indicates the relationship between the users U in the group. Even with this configuration, the information processing apparatus 1 is able to provide a more appropriate advertisement to the users in the chat group.

Furthermore, the generation processing unit 51 is able to generate, as the advertisement selection information, information that includes at least one of the information that indicates the situation of the group in the chat room, the information that indicates the characteristic of each of the users U, and the information that indicates the relationship between the users U in the group, in addition to the information that indicates the type of the advertisement.

### 6. Hardware Configuration

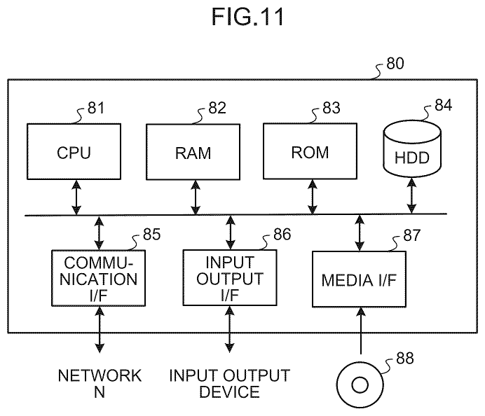

The information processing apparatus 1 according to one embodiment as described above is implemented by, for example, a computer 80 that has a configuration as illustrated in FIG. 11. FIG. 11 is a diagram illustrating an example of a hardware configuration of the computer 80 that implements the functions of the information processing apparatus 1 according to one embodiment. The computer 80 includes a CPU 81, a RAM 82, a Read Only Memory (ROM) 83, a Hard Disk Drive (HDD) 84, a communication interface (I/F) 85, an input output interface (I/F) 86, and a media interface (I/F) 87.

The CPU 81 operates based on a program that is stored in the ROM 83 or the HDD 84, and controls each of the units. The ROM 83 stores therein a boot program that is executed by the CPU 81 at the time of activation of the computer 80, a program that is dependent on hardware of the computer 80, and the like.

The HDD 84 stores therein a program that is executed by the CPU 81, data that is used by the program, and the like. The communication interface 85 receives data from a different apparatus via the network N (see FIG. 2), sends the data to the CPU 81, and transmits data that is generated by the CPU 81 to a different apparatus via the network N.

The CPU 81 controls an output device, such as a display and a printer, and an input device, such as a keyboard or a mouse, via the input output interface 86. The CPU 81 acquires data from the input device via the input output interface 86. Further, the CPU 81 outputs generated data to the output device via the input output interface 86.

The media interface 87 reads a program or data that is stored in a recording medium 88, and provides the program or the data to the CPU 81 via the RAM 82. The CPU 81 loads the program from the recording medium 88 onto the RAM 82 via the media interface 87, and executes the loaded program. The recording medium 88 is, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 80 functions as the information processing apparatus 1 according to one embodiment, the CPU 81 of the computer 80 executes a program that is loaded on the RAM 82 and implements the functions of the processing unit 12. Further, the HDD 84 stores therein data in the storage unit 11. The CPU 81 of the computer 80 reads the programs from the recording medium 88 and executes the programs; however, as another example, it may be possible to acquire the programs from a different apparatus via the network N.

### 7. Others

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the information processing apparatus 1 as described above may be implemented by a terminal apparatus and a server computer, may be implemented by a plurality of server computers, or may be implemented by calling an external platform or the like for some of the functions via an API, network computing, or the like, and the configuration may be flexibly changed.

Furthermore, the embodiments and the modifications as described above may be appropriately combined as long as processing contents do not conflict with each other.

### 8. Effects

As described above, the information processing apparatus 1 according to one embodiment includes the identification unit 41, the inquiry unit 42, the generation unit 43, and the providing unit 44. The identification unit 41 identifies the plurality of personal agents PA each being associated with the corresponding user U among the plurality of users U who are grouped. The inquiry unit 42 makes an inquiry to the plurality of personal agents PA that are identified by the identification unit 41 about information that is used to provide an advertisement to a group corresponding to the plurality of users U. The generation unit 43 generates advertisement selection information that is information that is used to select the advertisement, by using pieces of information that are provided by the plurality of personal agents PA in response to the inquiry that is made by the inquiry unit 42. The providing unit 44 provides the advertisement selection information that is generated by the generation unit 43 to an advertisement provider. With this configuration, the information processing apparatus 1 is able to provide a more appropriate advertisement to the users U in the chat group. With this configuration, the information processing apparatus 1 is able to provide a more appropriate advertisement to the users U who are grouped.

Furthermore, the providing unit 44 provides, to the group, an advertisement that is provided by the advertisement provider in response to provision of the advertisement selection information. With this configuration, the information processing apparatus 1 is able to provide a more appropriate advertisement to the users U who are grouped.

Moreover, the generation unit 43 includes the estimation processing unit 50 that estimates a persona of the group based on pieces of information that are provided by the plurality of personal agents PA in response to an inquiry that is made by the inquiry unit 42, and the generation processing unit 51 that generates the advertisement selection information based on the persona of the group that is estimated by the estimation processing unit 50. With this configuration, the information processing apparatus 1 is able to provide a more appropriate advertisement to the users U who are grouped.

Furthermore, the estimation processing unit 50 estimates, as the persona of the group, one of a common attribute and a common interest among the plurality of users U. With this configuration, the information processing apparatus 1 is able to provide a more appropriate advertisement to the users U who are grouped.

Moreover, the information processing apparatus 1 further includes the reception unit 40 that receives setting to form a group of the plurality of users U for a group chat among the plurality of users U. With this configuration, the information processing apparatus 1 is able to provide a more appropriate advertisement to the users U in the chat group.

Furthermore, the generation unit 43 includes the estimation processing unit 50 that estimates a situation of the group in a chat room by using the generative AI based on message histories of the plurality of users U in the chat room of the group chat, and the generation processing unit 51 that generates the advertisement selection information based on the situation that is estimated by the estimation processing unit 50. With this configuration, the information processing apparatus 1 is able to provide a more appropriate advertisement to the users U in the chat group.

Moreover, each of the personal agents PA makes an inquiry to the user U if it is possible to provide information corresponding to the inquiry, and provides the information corresponding to the inquiry based on an answer that is given by the user U. With this configuration, the personal agent PA is able to prevent provision of information before the user U realizes.

Thus, embodiments of the present application have been described in detail above based on the drawings, but the embodiments are described by way of example, and the present invention may be made in various different modes with various modifications and improvement based on knowledge of a person skilled in the art, in addition to the embodiments described in the section of the disclosure of the invention.

In addition, the “unit (section, module, unit)” described above may be replaced with a “means”, a “circuit”, or the like. For example, the acquisition unit may be replaced with an acquisition means or an acquisition circuit.

According to one aspect of embodiments, it is possible to provide a more appropriate advertisement to users in a chat group.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an identification unit that identifies a plurality of personal agents each being associated with a corresponding user among a plurality of users who are grouped;
an inquiry unit that makes an inquiry to the plurality of personal agents that are identified by the identification unit about information that is used to provide an advertisement to a group corresponding to the plurality of users;
a generation unit that generates advertisement selection information that is information that is used to select the advertisement by using pieces of information that are provided by the plurality of personal agents in response to the inquiry that is made by the inquiry unit; and
a providing unit that provides the advertisement selection information that is generated by the generation unit to an advertisement provider.

2. The information processing apparatus according to claim 1, wherein the providing unit provides, to the group, an advertisement that is provided by the advertisement provider in response to provision of the advertisement selection information to the group.

3. The information processing apparatus according to claim 1, wherein
the generation unit includes
an estimation processing unit that estimates a persona of the group based on pieces of information that are provided by the plurality of personal agents in response to an inquiry that is made by the inquiry unit; and
a generation processing unit that generates the advertisement selection information based on the persona of the group that is estimated by the estimation processing unit.

4. The information processing apparatus according to claim 3, wherein the estimation processing unit estimates, as the persona of the group, one of a common attribute and a common interest among the plurality of users.

5. The information processing apparatus according to claim 1, further comprising:
a reception unit that receives setting to form a group of the plurality of users for a group chat among the plurality of users.

6. The information processing apparatus according to claim 5, wherein
the generation unit includes
an estimation processing unit that estimates a situation of the group in a chat room by using the generative AI based on message histories of the plurality of users U in the chat room of the group chat; and
a generation processing unit that generates the advertisement selection information based on the situation that is estimated by the estimation processing unit.

7. The information processing apparatus according to claim 1, wherein each of the personal agents makes an inquiry to the user if it is possible to provide information corresponding to the inquiry, and provides the information corresponding to the inquiry based on an answer that is given by the user.

8. An information processing method hat is implemented by a computer, the information processing method comprising:
identifying a plurality of personal agents each being associated with a corresponding user among a plurality of users who are grouped;
making an inquiry to the plurality of personal agents that are identified at the identifying about information that is used to provide an advertisement to a group corresponding to the plurality of users;
generating advertisement selection information that is information that is used to select the advertisement by using pieces of information that are provided by the plurality of personal agents in response to the inquiry that is made at the making the inquiry; and
provides the advertisement selection information that is generated at the generating to an advertisement provider.

9. A non-transitory computer readable storage medium having stored therein an information processing program that causes a computer to execute a process, the process comprising:
identifying a plurality of personal agents each being associated with a corresponding user among a plurality of users who are grouped;
making an inquiry to the plurality of personal agents that are identified at the identifying about information that is used to provide an advertisement to a group corresponding to the plurality of users;
generating advertisement selection information that is information that is used to select the advertisement by using pieces of information that are provided by the plurality of personal agents in response to the inquiry that is made at the making the inquiry; and
provides the advertisement selection information that is generated at the generating to an advertisement provider.
